(19) United States
(12) Patent Application Publication
(10) Pub. No.: US 2024/0033160 A1
(43) Pub. Date: Feb. 1, 2024

(54) NEGATIVE-PRESSURE MASSAGE MACHINE WITH DOUBLE GAS TRANSMISSION STRUCTURE

(71) Applicants: Po-Chang LIU, TAOYUAN CITY (TW); BIBOTING INTERNATIONAL CO., LTD., TAOYUAN CITY (TW)

(72) Inventors: Shih-Ta LIU, TAOYUAN CITY (TW); Po-Chang LIU, TAOYUAN CITY (TW); Pei-En LEE, New Taipei City (TW)

(21) Appl. No.: 17/878,486

(22) Filed: Aug. 1, 2022

(51) Int. Cl. A61H 7/00

(52) U.S. Cl. CPC A61H 7/008

(57) ABSTRACT

A massage machine includes a main body, a first and a second gas transmission structures. The main body includes a casing and a panel. The first gas transmission structure includes a first outlet tube, a gas suction tank, a vacuum pump and a first connecting tube. The first outlet tube is disposed on the panel and communicates with the gas suction tank. The vacuum pump communicates with the gas suction tank through the first connecting tube. The second gas transmission structure includes a second outlet tube, a gas intake tank, an electromagnetic valve, a second connecting tube and a third connecting tube. The second outlet tube is disposed on the panel. The gas intake tank communicates with the second outlet tube through the second connecting tube. The electromagnetic valve communicates with the gas intake tank and communicates with the gas suction tank through the third connecting tube.

### BACKGROUND

### Technical Field

The disclosure relates to a negative-pressure massage machine, particularly to a negative-pressure massage machine with a double gas transmission structure.

### Description of Related Art

As the pace of life is getting faster and faster, modern people often do not have enough time to exercise to relax their body and mind, or accumulate a lot of pressure to be relieved. Therefore, there are many kinds of massage and pressure relief equipment on the market. A related-art negative-pressure massage device includes a massage host, a gas transmission tube, and a vacuum cup. Two ends of the gas transmission tube are separately connected to the massage host and the vacuum cup. A user utilizes the operation of the massage host and implements suction or exhaust on a portion of the user's body to accomplish the effects of massage and relaxation.

However, most of the related-art negative-pressure massage devices can only be used for external devices with a single function, and cannot be used comprehensively for other functions such as an oxygen injector, a negative-ion generator, ozone generation, hydroxide ions generation, etc., the other related devices or equipment must be purchased separately, which will cause a heavy cost burden to users.

In view of this, the inventors have devoted themselves to the above-mentioned related art, researched intensively and cooperated with the application of science to try to solve the above-mentioned problems. Finally, the invention which is reasonable and effective to overcome the above drawbacks is provided.

### SUMMARY

An object of the disclosure is to provide a negative-pressure massage machine with a double gas transmission structure, which may be used with a negative-pressure cup device, and provided for the other external devices. Thus, the adaptability and multi-functionality may be improved.

To accomplish the above object, the disclosure provides a negative-pressure massage machine with a double gas transmission structure, which includes a main body, a first gas transmission structure and a second gas transmission structure. The main body includes a casing and a panel connected with the casing. The first gas transmission structure includes a first outlet tube, a gas suction tank, a vacuum pump and a first connecting tube. The first outlet tube is disposed on the panel. The gas suction tank communicates with the first outlet tube. The vacuum pump is disposed in the casing and communicates with the gas suction tank through the first connecting tube. The second gas transmission structure includes a second outlet tube, a gas intake tank, an electromagnetic valve, a second connecting tube and a third connecting tube. The second outlet tube is disposed on the panel. The gas intake tank is disposed in the casing and communicates with the second outlet tube through the second connecting tube. The electromagnetic valve is disposed in the casing and communicates with the gas intake tank. The electromagnetic valve communicates with the gas suction tank through the third connecting tube.

The disclosure further has the following functions. The first outlet tube and the second outlet tube disposed on the panel may facilitate plugging and removing the negative-pressure cup device and the external device.

### BRIEF DESCRIPTION OF THE DRAWINGS

FIG. 1 is an assembled perspective view of the negative-pressure massage machine of the disclosure;

FIG. 2 is an exploded view of the negative-pressure massage machine of the disclosure;

FIG. 3 is a block diagram of the negative-pressure massage machine of the disclosure;

FIG. 4 is an exploded view of the first outlet tube and the gas suction tank of the disclosure; and

FIG. 5 is an exploded view of the gas intake tank of the disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

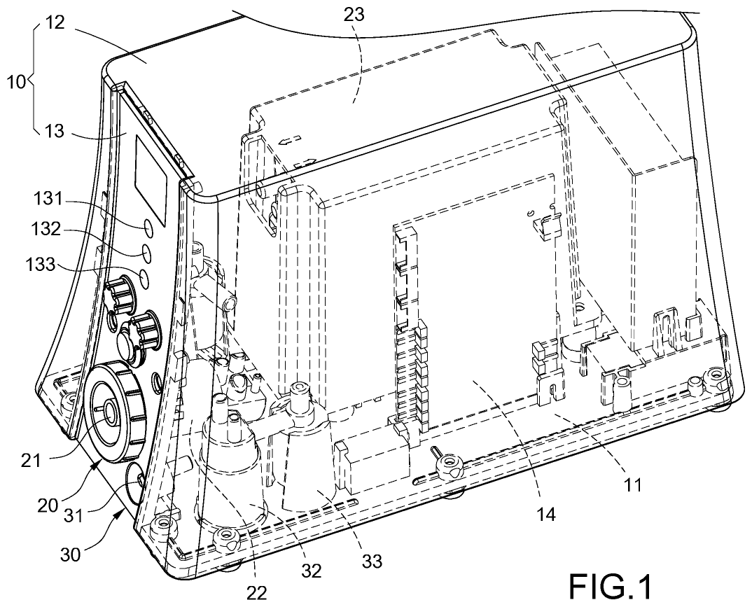

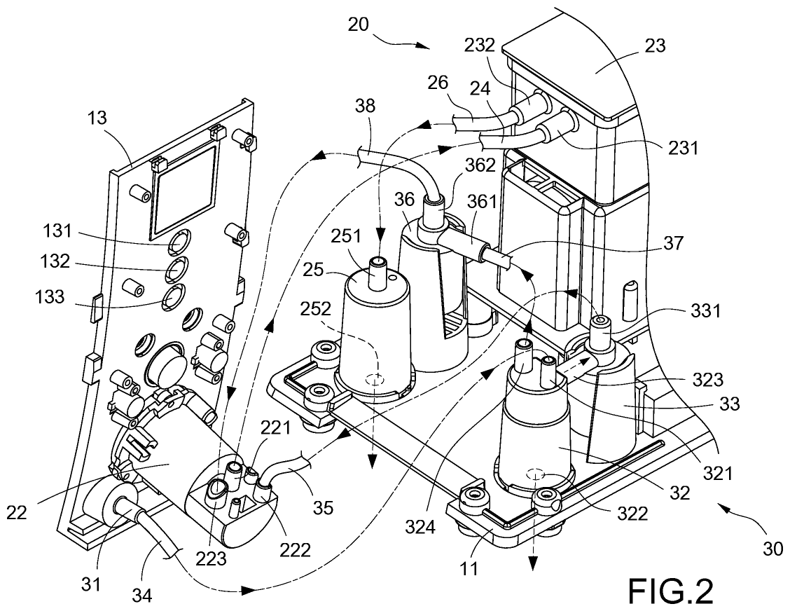

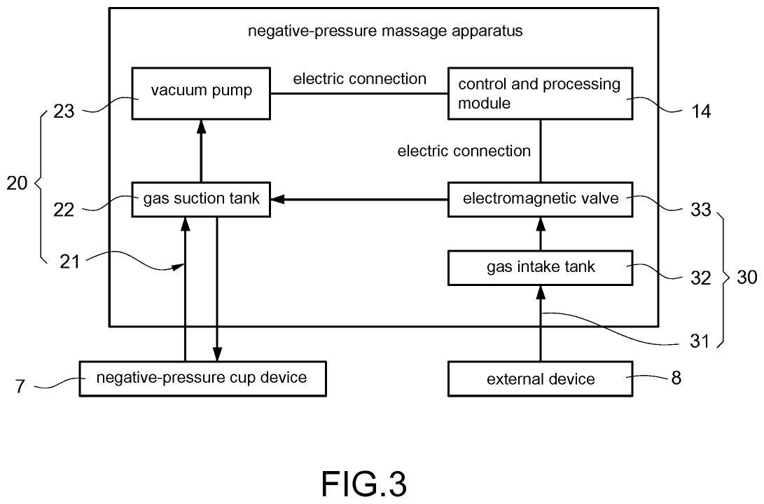

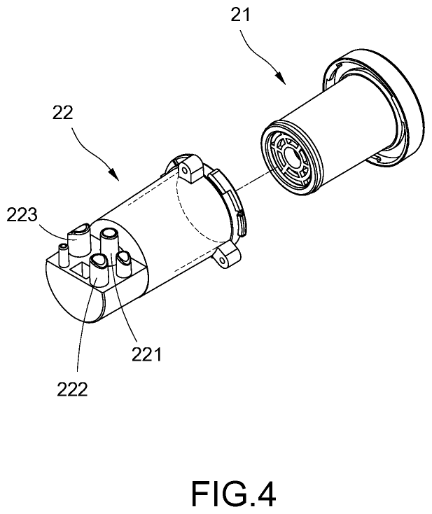

Please refer to FIGS. 1-4. The disclosure provides a negative-pressure massage machine with a double gas transmission structure, which may be used with a negative-pressure cup device 7 (as shown in FIG. 3) and/or an external device 8 (as shown in FIG. 3) to jointly form a negative-pressure massage apparatus. The negative-pressure massage machine includes a main body 10, a first gas transmission structure 20 and a second gas transmission structure 30.

The main body 10 is of a substantially trapezoidal shape and includes a base 11, a casing 12 and a panel 13. The casing 12 covers the base 11 correspondingly. The panel 13 is fixed on the front side of the casing 12. In the embodiment, the panel 13 is disposed with a blue key 131, a yellow key 132, a red key 133 and the other related elements such as a knob, a buzzer, a display, and a switch, etc.

The first gas transmission structure 20 includes a first outlet tube 21, a gas suction tank 22, a vacuum pump 23 and a first connecting tube 24. The first outlet tube 21 is disposed on the front of the panel 13 for connecting the negative-pressure cup device 7. The gas suction tank 22 is fixed on the back of the panel 13 and communicates with the first outlet tube 21. The gas suction tank 22 has a gas suction port 221, a first gas leakage port 222 and a second gas leakage port 223. The detailed structures, connection type and operation manner of the gas suction tank 22 and the first outlet tube 21 are shown in Taiwan utility model patent No. TWM621904 applied by the same inventor and has been granted, and here is omitted for brevity.

The vacuum pump 23 is fixed on the base 11 and formed in the casing 12. The vacuum pump 23 has a gas intake port 231 and a gas exhaust port 232. Two ends of the first connecting tube 24 separately communicate with the gas intake port 231 of the vacuum pump 23 and the gas suction port 221 of the gas suction tank 22.

The second gas transmission structure 30 includes a second outlet tube 31, a gas intake tank 32, an electromagnetic valve 33, a second connecting tube 34 and a third connecting tube 35. The second outlet tube 31 is disposed on the front of the panel 13 and located on the side of the first outlet tube 21 for connecting the external device 8 such as an oxygen injector, a negative-ion, ozone, or hydroxide ions generator, etc. The gas intake tank 32 is fixed on the base 11 and formed in the casing 12. The gas intake tank 32 has a gas intake port 321, a gas exhaust opening 322, a gas output tube 323 and a gas output port 324. Two ends of the second connecting tube 34 separately communicate with the second outlet tube 31 and the gas intake port 321 of the gas intake tank 32.

The electromagnetic valve 33 is fixed on the base 11 and located on one side of the gas intake tank 32. The electromagnetic valve 33 communicates with the gas intake tank 32 through the gas output tube 323. Also, the electromagnetic valve 33 has a gas output port 331. Two ends of the third connecting tube 35 separately communicate with the gas output port 331 of the electromagnetic valve 33 and the first gas leakage port 222 of the gas suction tank 22.

In an embodiment, the main body 10 further includes a control and processing module 14. The control and processing module 14 is disposed on one side of the vacuum pump 23 and electrically connected to the vacuum pump 23 and the electromagnetic valve 33.

In an embodiment, the first gas transmission structure 20 further includes a gas leakage tank 25 and a fourth connecting tube 26. The gas leakage tank 25 is fixed on the base 11 and formed in the casing 12. The gas leakage tank 25 has a gas intake port 251 and a gas exhaust opening 252. Two ends of the fourth connecting tube 26 separately communicate with the gas exhaust port 232 of the vacuum pump 23 and the gas intake port 251 of the gas leakage tank

In an embodiment, the second gas transmission structure 3 further includes another electromagnetic valve 36, a fifth connecting tube 37 and a sixth connecting tube 38. The another electromagnetic valve 36 is fixed on the base 11 and formed on the side of the gas leakage tank 25. The another electromagnetic valve 36 has a gas intake port 361 and a gas output port 362. Two ends of the fifth connecting tube 37 separately communicate with the gas output port 324 of the gas intake tank 32 and the gas intake port 361 of the another electromagnetic valve 36. Two ends of the sixth connecting tube 38 separately communicate with the gas output port 362 of the another electromagnetic valve 36 and the second gas leakage port 223 of the gas suction tank 22.

By the assembly of the above components, the operation process has the following modes.

In the blue key mode of the instrument (i.e., the blue key 131 lights up), the another electromagnetic valve 36 is continuously turned off to open to leak gas for few seconds, the vacuum pump 23 is turned on to perform vacuum-pumping for few seconds, and the actions are repeated. The external device 8 is filled with gas such as pure oxygen, negative ions, ozone, and hydroxide ions through the second outlet tube 31, the gas enters the gas intake tank 32 from the gas intake port 321 through the second connecting tube 34. When the electromagnetic valve 33 is turned on, the gas flows to the negative-pressure cup device 7 through the gas outlet tube 323, the gas output port 331 of the electromagnetic valve 33, the third connecting tube 35, the second gas leakage port 223 and the gas suction tank 22. When the electromagnetic valve 33 is turned off, the gas is being ejected from the gas exhaust opening 322 of the gas intake tank 32.

In the yellow key mode of the instrument (i.e., the yellow key 132 lights up), the electromagnetic valve 33 is continuously turned off, after the another electromagnetic valve 36 is turned on to leak gas for few seconds, the vacuum pump 23 is turned on to perform vacuum-pumping for few seconds, and the actions are repeated. The external device 8 is filled with gas such as pure oxygen, negative ions, ozone and/or hydroxide ions through the second outlet tube 31, the gas enters the gas intake tank 32 from the gas intake port 321 through the second connecting tube 34. When the electromagnetic valve 33 is turned on, the gas flows to the negative-pressure cup device 7 through the gas outlet port 324, the fifth connecting tube 37, the gas intake port 361, the another electromagnetic valve 36, the gas output port 362, the sixth connecting tube 38, the first gas leakage port 222 and the gas intake tank 22. When the electromagnetic valve 33 is turned off, the gas is being ejected from the gas exhaust opening 322 of the gas intake tank 32.

In the red key mode of the instrument (i.e., the red key 133 lights up), the electromagnetic valve 33 and the another electromagnetic valve 36 are continuously turned off, the vacuum pump 23 is turned on to continuously perform vacuum-pumping. The external device 8 is filled with gas such as pure oxygen, negative ions, ozone and/or hydroxide ions through the second outlet tube 31, the gas enters the gas intake tank 32 from the gas intake port 321 through the second connecting tube 34, and the gas is being ejected from the gas exhaust opening 322 of the gas intake tank 32.

In the blue key mode and the red key mode of the instrument (i.e., both the blue key 131 and the red key 133 simultaneously light up), the another electromagnetic valve 36 is continuously turned off, the electromagnetic valve 33 is turned on to leak gas for few seconds and then turned off for few seconds, and the actions are repeated. The vacuum pump 23 is turned on to continuously perform vacuum-pumping.

In the yellow key mode and the red key mode of the instrument (i.e., both the yellow key 132 and the red key 133 simultaneously light up), the electromagnetic valve 33 is continuously turned off, the another electromagnetic valve 36 is turned on to leak gas for few seconds and then turned off for few seconds, and the actions are repeated. The vacuum pump 23 is turned on to continuously perform vacuum-pumping.

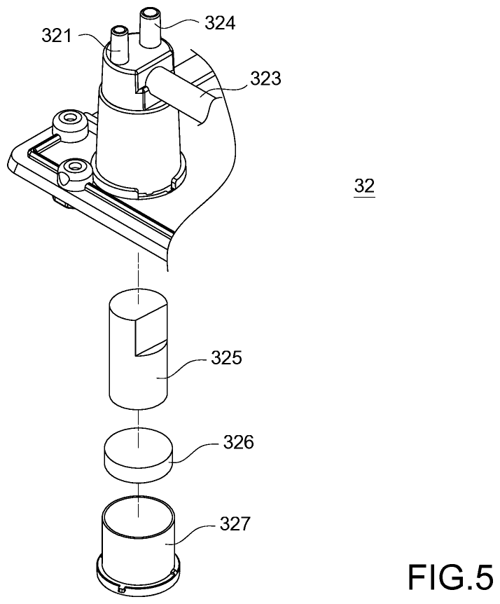

Please refer to FIG. 5. The gas intake tank 32 further includes a filter member and a cap 327. The filter member is disposed in the gas intake tank 32. The cap 327 is fixed at an end of the gas intake tank 32. The filter member includes a first filter core 325 and a second filter core 326. The first filter core 325 and the second filter core 326 are laminated with each other. The first filter core 325 may be a filtering sponge and the second filter core 326 may be an active carbon filter or a High-Efficiency Particulate Gas (HEPA) filter. The HEPA filter is made of chemical fibers with irregular distribution (such as non-woven fabric of polypropylene fibers or polyester) or glass fiber for clean intake.

While this disclosure has been described by means of specific embodiments, numerous modifications and variations could be made thereto by those skilled in the art without departing from the scope and spirit of this disclosure set forth in the claims.

What is claimed is:

1. A negative-pressure massage machine with a double gas transmission structure, the negative-pressure massage machine comprising:
a main body, comprising a casing and a panel connected with the casing;
a first gas transmission structure, comprising a first outlet tube, a gas suction tank, a vacuum pump and a first connecting tube, the first outlet tube disposed on the panel, the gas suction tank communicating with the first outlet tube, the vacuum pump disposed in the casing and communicating with the gas suction tank through the first connecting tube; and
a second gas transmission structure, comprising a second outlet tube, a gas intake tank, an electromagnetic valve, a second connecting tube and a third connecting tube, the second outlet tube disposed on the panel, the gas intake tank disposed in the casing and communicating with the second outlet tube through the second connecting tube, the electromagnetic valve disposed in the casing and communicating with the gas intake tank, and the electromagnetic valve communicating with the gas suction tank through the third connecting tube.

2. The negative-pressure massage machine of claim 1, wherein the gas intake tank comprises a gas intake port, and two ends of the second connecting tube separately communicate with the second outlet tube and the gas intake port of the gas intake tank.

3. The negative-pressure massage machine of claim 2, wherein the gas suction tank comprises a first gas leakage port, the electromagnetic valve comprises a gas output port, and two ends of the third connecting tube separately communicate with the gas output port of the electromagnetic valve and the first gas leakage port of the gas suction tank.

4. The negative-pressure massage machine of claim 2, wherein the gas intake tank further comprises a gas output tube, and the electromagnetic valve communicates with the gas intake tank through the gas output tube.

5. The negative-pressure massage machine of claim 4, wherein the second gas transmission structure further comprises another electromagnetic valve and a fifth connecting tube, the gas intake tank further comprises a gas output port, the another electromagnetic valve comprises a gas intake port, and two ends of the fifth connecting tube separately communicate with the gas output port of the gas intake tank and the gas intake port of the another electromagnetic valve.

6. The negative-pressure massage machine of claim 5, wherein the second gas transmission structure further comprises a sixth connecting tube, the another electromagnetic valve comprises a gas output port, the gas suction tank further comprises a second gas leakage port, and two ends of the sixth connecting tube separately communicate with the gas output port of the another electromagnetic valve and the second gas leakage port of the gas suction tank.

7. The negative-pressure massage machine of claim 1, wherein the gas intake tank comprises a gas intake port, a gas exhaust opening, a gas output tube, and a gas output port communicating with one another.

8. The negative-pressure massage machine of claim 1, wherein the gas suction tank comprises a gas suction port, the vacuum pump comprises a gas intake port, and two ends of the first connecting tube separately communicate with the gas intake port of the vacuum pump and the gas suction port of the gas suction tank.

9. The negative-pressure massage machine of claim 8, wherein the first gas transmission structure further comprises a gas leakage tank and a fourth connecting tube, the vacuum pump further comprises a gas exhaust port, the gas leakage tank is disposed in the casing, the gas leakage tank comprises a gas intake port, and two ends of the fourth connecting tube separately communicate with the gas exhaust port of the vacuum pump and the gas intake port of the gas leakage tank.

10. The negative-pressure massage machine of claim 1, wherein the main body further comprises a control and processing module, and the control and processing module is electrically connected to the vacuum pump and the electromagnetic valve.

11. The negative-pressure massage machine of claim 1, wherein the gas intake tank comprises a filter member disposed inside.

12. The negative-pressure massage machine of claim 11, wherein the filter member comprises a first filter core and a second filter core laminated on the first filter core, the first filter core is a filtering sponge, and the second filter core is an active carbon filter or a High-Efficiency Particulate Gas (HEPA) filter.
